(19) United States
(12) Patent Application Publication
(10) Pub. No.: US 2007/0262862 A1
(43) Pub. Date: Nov. 15, 2007

(54) Monitoring and tracking system

(75) Inventors: Michael Barrett, Buffalo Grove, IL (US); J. Patrick Costello, Arlington Hgts, IL (US); James M. Duggan, Lake Forest, IL (US); Michael William Grivas, Northbrook, IL (US); Mark Mastroianni, Arlington Heights, IL (US); Jeffrey D. Querrey, Downers Grove, IL (US); Mark Alan Zickert, Arlington Heights, IL (US)

Correspondence Address: BRINKS HOFER GILSON & LIONE, P.O. BOX 10395, CHICAGO, IL, 60610, US

(73) Assignee: iChaperone, LLC

(21) Appl. No.: 11/432,916

(22) Filed: May 12, 2006

(51) Int. Cl. G08B 1/08; G08B 23/00

(52) U.S. Cl. 340/539.15; 340/539.21; 340/573.4

(57) ABSTRACT

The disclosed system and method may monitor and track people, objects or assets. A monitoring unit can monitor and track a number of monitored units. When a monitored unit exceed a certain distance from the monitoring unit an alarm is triggered to notify both the monitoring unit and the monitored unit. A parent or teacher may utilize a monitoring unit for a group of kids whom all have a monitored unit. The parent or teacher can easily monitor and track the kids with a monitoring system. Alternatively, the monitoring system can be used in a nursing home situation, for tracking pets, or other assets.

### TECHNICAL FIELD

The present embodiments relate generally to a system and method for monitoring and tracking people, objects or assets.

### BACKGROUND

In many scenarios it would be useful to have a monitoring or tracking system to monitor people, objects or assets. One of those scenarios is a field trip with a teacher. The teacher is responsible for watching over a group of children, which can be a formidable task. A monitoring and tracking system can significantly improve the teacher's ability to watch over a number of kids. Alternatively, a parent on vacation can use a monitoring system when traveling. The monitoring system should be able to allow the parent or teacher to know when the children they are monitoring have wondered off. There are many other examples where such a system could provide substantial benefits.

Currently, monitoring systems on the market are insufficient in many respects. Many monitoring systems may be limited by the number of subjects that can be monitored. Limiting the number of monitored subjects fundamentally limits the application of the system to scenarios in which no more than the maximum number of subjects are present. For example, if the system is limited to ten subjects, then the system cannot be used for a field trip with eleven or more students. In addition it may be desirable to have multiple monitoring units, each unit monitoring a number of subjects. However, many current monitoring systems may have interference between the multiple monitoring units and between the subjects that are monitored, which degrades the effectiveness of the system.

In addition, existing monitoring systems may be limited by the distance or range in which the monitoring can cover. A limited range could result in an alarm or notification of a lost child despite the fact the child may be only a short distance away. Certain scenarios may require an increased range for effective monitoring.

Existing monitoring systems are not always reliable. For a monitoring system to be effective it must be reliable and trustworthy. Parents will not trust an unreliable monitoring system to help them watch their kids. A monitoring device with a poor battery life may run out of energy and not function properly causing a parent to incorrectly assume their child is within range.

Another shortcoming of many current systems is the synchronization of a monitoring device with devices that will be monitored. As discussed above, in scenarios with multiple monitoring devices, which are assigned certain monitored devices, there should not be interference or confusion regarding which monitored devices are monitored by which monitoring device. Accurately assigning or synchronizing monitored devices with monitoring devices is important for reliability.

The alarm mechanisms in existing monitoring systems may be ineffectual in a number of scenarios. Many existing monitoring systems do not include an alarm on the monitored unit, but only on the monitoring unit. In the case of disabled persons, such as blind or deaf children or adults, the alarm mechanisms in existing monitoring systems may not alert the child that he/she is outside of the range. In many scenarios, it may also be necessary for the alarm to be triggered if the monitored device is removed from the subject. If a monitored device falls off of a wearer, that person would then be free to move outside of range unless an alarm is triggered.

There are additional concerns with existing monitoring systems. The size of a device can effect how useful the system may be. Very bulky devices are not convenient for a child to have or carry. In particular, a small child cannot have a large device attached to their clothing or body without being inconvenienced. The physical durability of a monitoring device is also important. It is very possible that a child will drop the device, so it needs to be physically strong. Merely dropping the device should not cause it to malfunction. Cost may also be a factor effecting who can afford and use a monitoring system. A cost-effective solution is desirable. Many existing monitoring systems suffer from one or more of these deficiencies.

### BRIEF SUMMARY

By way of introduction, the embodiments described below include a method and system for monitoring and tracking people, objects or assets. The embodiments relate to using a device to monitor assets, wherein each of the assets has a device that is monitored. The embodiments further relate to a method and system of monitoring and tracking the devices using wireless communications.

In a first aspect, a system is disclosed including a parent unit, wherein the parent unit transmits signals; and at least one child unit which receives the transmitted signals from the parent unit, wherein the at least one child unit initiates an alarm upon failing to receive the transmitted signal from the parent unit after a predetermined amount of time; and further wherein the parent unit is operable to identify the at least one child unit when the at least one child unit fails to respond to the transmitted signal from the parent unit and initiates an alarm.

In a second aspect, a method is disclosed which includes steps of: providing a parent device and at least one child device; synchronizing the at least one child device with the parent device; communicating signals between the parent device and the at least one child device; initiating an alarm on the at least one child device when the at least one child device fails to receive a predetermined number of signals from the parent device; and identifying the at least one child device that initiates the alarm.

In a third aspect, a system is disclosed including a monitoring unit; at least one monitored unit which communicates with the monitoring unit, wherein the monitoring unit is operable to determine if the monitored unit exceeds a certain distance from the monitoring unit; and a synchronization device, wherein the synchronization device is a cradle that receives the monitoring unit and the at least one monitored unit and associates the monitoring unit with the at least one monitored unit.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims and be defined by the following claims. Nothing in this section should be taken as a limitation on those claims. Further aspects and advantages are discussed below in conjunction with the preferred embodiments.

### BRIEF DESCRIPTION OF THE DRAWINGS

FIG. 1 is a diagram of an embodiment of a monitoring system;

FIG. 2 is a flow chart of an embodiment of a method for monitoring;

FIG. 3 is a flow chart of an embodiment of synchronization;

FIG. 4 is a diagram of a synchronization cradle;

FIG. 5 is a diagram of the timing of an embodiment of a monitoring system;

FIG. 6 is a flow chart showing steps of identifying a missing child unit from the perspective of a parent unit according to one embodiment;

FIG. 7 is a flow chart showing steps of a missing child unit from the perspective of the missing child unit according to one embodiment; and

FIG. 8 is a flow chart showing the steps in a monitoring system according to one embodiment when a child unit is removed.

### DETAILED DESCRIPTION OF THE DRAWINGS AND THE PRESENTLY PREFERRED EMBODIMENTS

The principles described herein may be embodied in many different forms. Generally, the embodiments relate to a monitoring and tracking system. A single “parent unit” communicates by radio with one or more “child units.” The parent unit may be referred to as a parent device, monitoring unit or monitoring device. The child unit may be referred to as a child device, monitored unit or monitored device. However, the terms “parent” and “child” are used here only for convenience and for illustration. The child unit may be disposed with any moveable object or asset, human or otherwise. Similarly, the parent unit may be disposed with any monitoring asset.

Typical envisioned uses for the system include a school field trip in which the teacher, teacher's aide or chaperone wears or carries the parent unit and is assigned to monitor a set number of children. Alternatively a parent may use the system to monitor his/her children. The system may used for patient tracking at a healthcare facility, or could be used for animal or pet monitoring and/or training. As mentioned above, for simplicity the monitored unit may be referred to as a child unit and the monitoring unit may be referred to as a parent unit despite the fact that a parent/child scenario is merely one possible use of the system.

Each child wears or carries a respective child unit. The system establishes an electronic boundary around the parent unit. If a child unit approaches the boundary, the child unit triggers an alarm. If multiple child units approach the boundary, multiple alarms are issued. If a child unit strays beyond the boundary, both the parent unit and the child unit trigger an alarm. The parent unit is equipped with a display that provides a visual indication of which child is “missing.” The visual indication may include a name or other identification of the missing child.

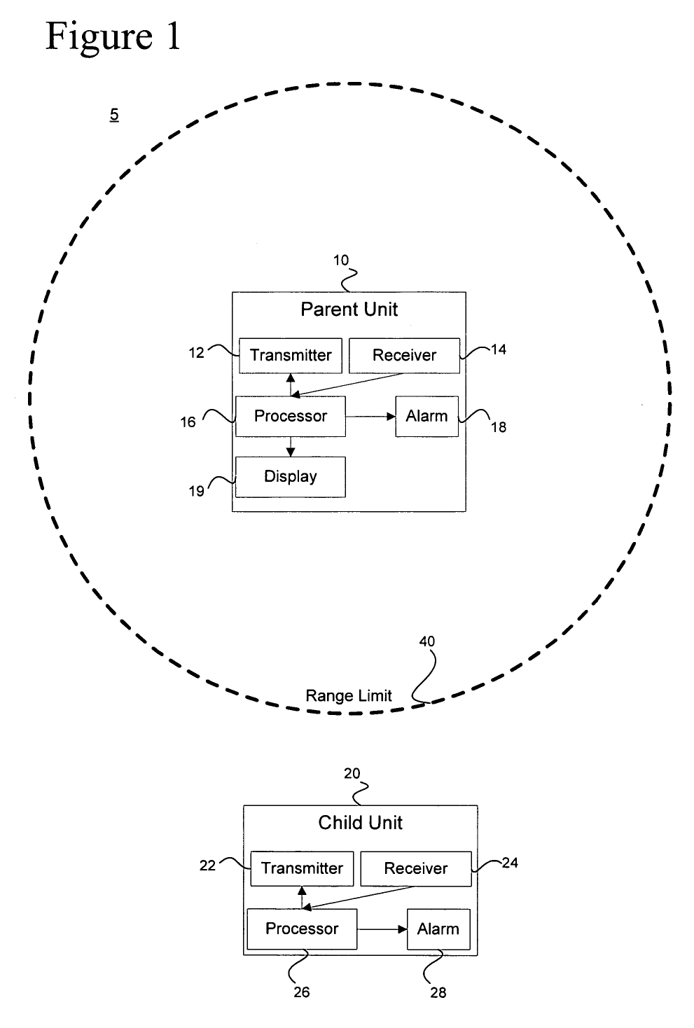

FIG. 1 is a diagram of an embodiment (not to scale) of a monitoring system 5. The system 5 includes a parent unit 10 and at least one child unit 20. The parent unit 10 monitors the at least one child unit 20. In different embodiments, there may be only one child unit or 35 child units for a field trip of students, or even potentially hundreds or thousands of child units. The parent unit 10 establishes an electric boundary or range limit 40. If the child unit 20 is outside of the range limit 40, an alarm is triggered on both the parent unit 10 and the child unit 20. In the illustrated embodiment, the range limit 40 is two dimensional and circular. In other embodiments, the range limit 40 may be three dimensional and hemispherical or any other shape. Further, the range limit will be affected by objects in the environment such as people and structures. The circular range limit 40 of FIG. 1 is intended to be exemplary only.

The parent unit 10 comprises a transmitter 12, a receiver 14, a processor 16, an alarm 18, and a display 19. The transmitter 12 transmits a signal out to the range limit. When the child unit 20 responds to the transmitted signal, the receiver 14 in the parent unit 10 receives the signal from the child unit 20. If the child unit 20 fails to respond to a number of the parent unit's transmitted signals, the alarm 18 is triggered. In addition, the display 19 may display information on the missing child unit 20. The processor 16 provides the transmitter 12 with the signals to transmit and analyzes the return signals received from the child unit 20. The processor 16 also provides the data and information to be displayed on the display 19. The processor may have memory for storing data or software instructions.

The child unit 20 comprises a transmitter 22, a receiver 24, a processor 26, and an alarm 28. The child unit 20 may also have a display (not shown), which may be as simple as one or more lights or light emitting diodes or more sophisticated such as a liquid crystal display. The receiver 24 receives a transmitted signal from the parent unit 10 and responds to the received signal by transmitting a response signal through the transmitter 22. The processor 26 receives the signals from the receiver 24 and provides the signals to be transmitted by the transmitter 22. If a signal is not received by the child unit 20 after a certain period of time, the alarm 28 is triggered. The signal transmitted by the transmitter 12 of the parent unit 10 establishes the range limit 40. If the child unit 20 is outside of the range limit 40, the receiver 24 of the child unit 20 will not receive the signals from the parent unit 10.

FIG. 1 shows one embodiment (not to scale) of a parent unit 10 and a child unit 20. The functioning and details of both the parent unit 10 and the child unit 20 will be further described below in conjunction with the subsequent figures.

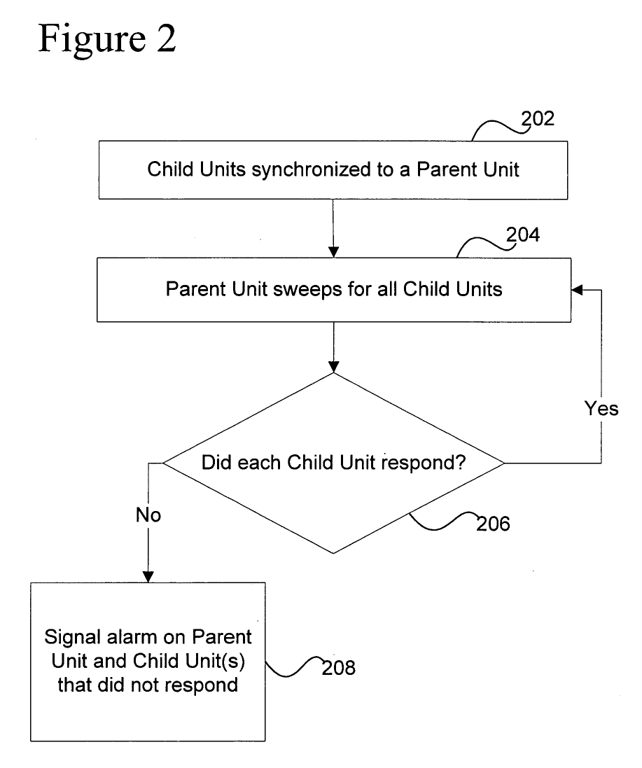

FIG. 2 is a flow chart of an embodiment of a method for monitoring. The method may be one embodiment for using the monitoring system embodiment described in FIG. 1. In block 202, the child units are synchronized to a parent unit. Synchronization is necessary to associate a set of child units with a particular parent unit. In one example, synchronization enables a field trip with multiple teachers that each have a unique parent unit and each monitor a certain number of different child units. Multiple parent units may only monitor a set number of child units. The synchronizing of each child unit with a single parent unit prevents interference between child units assigned to different parent units.

In an alternate embodiment, the system may be used for identifying or tracking animals or pets. For example, a pet owner may use the system as a method for training a dog. It could function as a shockless collar that notifies the pet when the boundary has been reached. A pet owner could train the pet where the boundary is that cannot be crossed. This technique is similar to an electric fence without the inhumane shocking of the pet. In another embodiment, the system may be used as identification for animals. This may be useful in a kennel for monitoring a large number of animals. The system can help to monitor and identify which pets are where.

In another alternate embodiment, the system may used for identifying or tracking patients in a hospital setting. For example, a nursing home may use the system to monitor patients. It would enable the healthcare professionals to identify and monitor where the location of the patients. An Alzheimer's unit would be an example where the patients have a tendency to wonder away and this system may relief some of the stress on the limited number of healthcare professionals monitoring a large number of patients.

In yet another embodiment, the system may be used for general asset tracking. A child unit may be coupled with any conceivable asset to be monitored enabling someone to track and identify the asset. For example, a manufacturer may use the system to monitor and track inventory. The parent unit may notify the user if a piece of inventory has been moved beyond a predetermined distance. One example of inventory may be arms or weaponry.

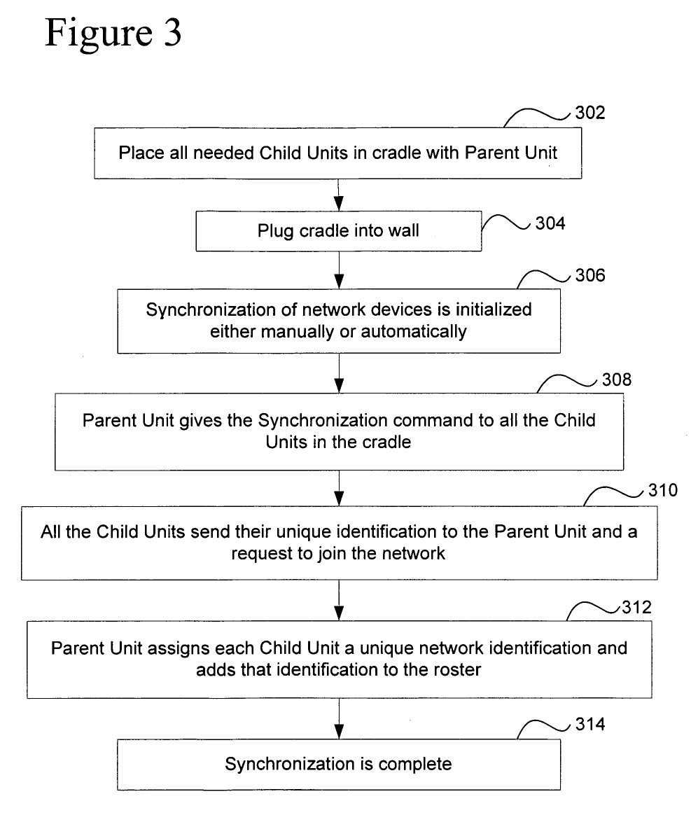

FIG. 3 is a flow chart of an embodiment of synchronization. In block 302, the child units are placed in a synchronization cradle with the parent unit to monitor those child units. In the synchronization cradle, the child units are in electrical communication with the parent unit for exchanging data and other information. The synchronization cradle is one embodiment of a system for synchronization of a parent unit with child units. In an alternate embodiment, the synchronization communication between parent and child units may be wireless.

The synchronization cradle may have many advantages including reliability and ease of use. In one application, the synchronization cradle may be located in a classroom next to or near the fire extinguisher or classroom door. In the case of an emergency, the students can be trained to grab and wear a child unit as they are exiting the classroom. For a teacher/student situation, there are at least five scenarios in which the system could be used, such as on field trips, during fire alarms, for special needs students, for safety training, and for disaster preparedness.

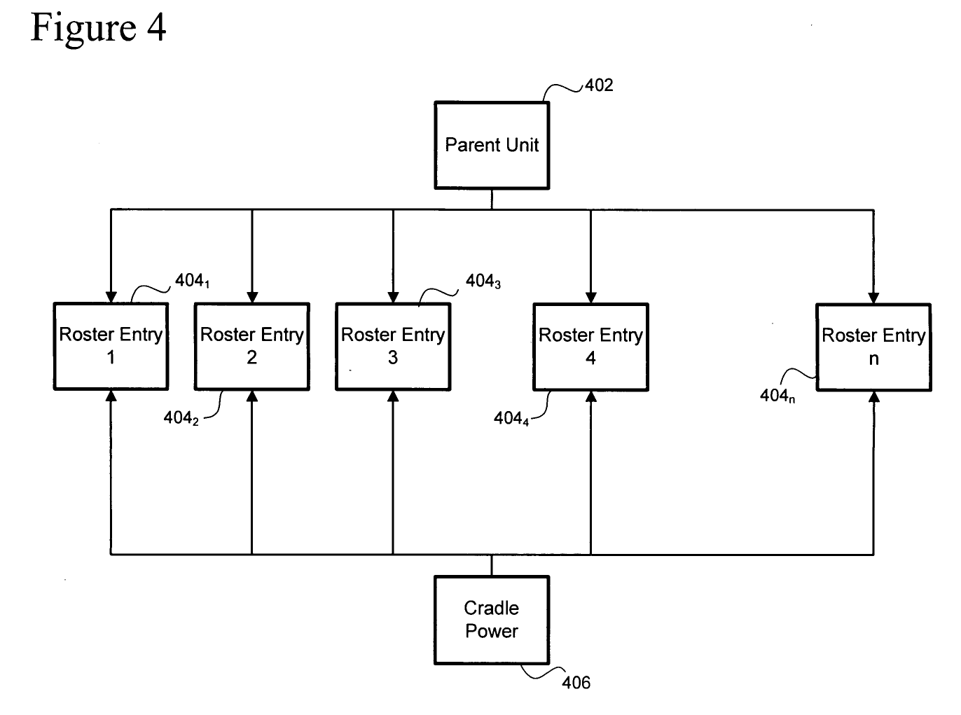

FIG. 4 is a diagram of a synchronization cradle. The parent unit 402 connects with each child unit or roster entry 404₁₋ₙ as shown in FIG. 4. Roster entry 1 404₁ is the first child unit, roster entry 2 404₂ is the second child, roster entry 3 404₃ is the third child unit, roster entry 4 404₄ is the fourth child unit, and there may be n child units shown by roster entry n 404ₙ. The synchronization cradle allows the parent unit 402 to synch with all the child units, roster entries 1-n 404₁₋ₙ. The synchronization cradle also provides cradle power 406 to each of the child units, roster entries 1-n 404₁₋ₙ and the parent unit 402.

Referring back to FIG. 3, in block 304, the synchronization cradle should be plugged into a power outlet on the wall. This wired synchronization cradle operates to associate a number of child units with a parent unit. In this embodiment, the cradle uses power from a standard wall outlet to power and charge the battery of the parent unit and the child units in the cradle. The cradle provides a convenient way for all of the units to be fully charged. Alternatively, the child units and parent units may have replaceable batteries rather than rechargeable batteries. In one embodiment, both the parent unit and child units would have a rechargeable Lithium-Ion battery. In an alternate embodiment, the battery may be a nickel metal hydride. The cradle may recharge the battery in both the parent unit and the child units. The batteries may have a multi-year lifespan based on the assumption that they are used about 40-50 hours each year. Other battery types may be substituted for particular applications. If the parent units and the child units are left in the synchronization cradle for long periods of time, the batteries may not be adversely affected or result in damage to the internal circuitry of any of the units.

In block 306, the synchronization of the units is initialized. In one embodiment, the child units are stored and charged in the cradle and when a parent unit is added or attached to the cradle, all of the child units are synchronized to that parent unit. The child units may automatically be synchronized with a parent unit when that parent unit is added to the cradle. In an alternate embodiment, the user may manually synchronize the parent unit with the child units. There may be a button on the cradle that the user presses to initiate synchronization.

In block 308, the parent unit transmits a signal to all the child units in the cradle to begin the synchronization. As discussed above, this may be initiated manually or automatically, but once initiated, the parent unit communicates with each of the child units. The signal sent by the parent unit is a notification that synchronization will begin. As a result, in block 310, all of the child units send a unique identification to the parent unit. In addition, each of the child units sends a request to join the network. The unique identification of the child unit may be a Media Access Control (MAC) address, which is a unique identifier that may be attached to networking equipment. In one embodiment, an Institute of Electrical and Electronics Engineers (IEEE) identifier may be used as the name or code assigned to each child unit. Possible IEEE identifiers are MAC-48, EUI-48, and EUI-64, which may be used in network protocols. The 64 bit EUI-64identifier assures that as many as 1024 unique codes can be in the same area and the parent units will not be confused over which child units it is assigned to monitor. The communication from the child unit is basically a request to be monitored by the parent unit and a notification to the parent unit of the child unit's unique identification.

In block 312, the parent unit assigns each child unit a unique network identification. Each child unit provides a unique identification, which the parent may then associate with its own network identification. This association allows for the parent unit to be able to identify each of the child units. This identification is used when the parent unit monitors each of the child units. In addition, the parent unit may maintain in memory a roster or listing of each of the child units that it is responsible for monitoring. This roster includes the identification of each child unit and is used by the parent unit to transmit signals to and receive responses from each of the child units on the roster. Once the parent unit identifies and creates a roster or list of each of the child units that it is responsible for, the synchronization is complete, as in block 314. In one embodiment, the synchronization cradle may have a sound or a light to indicate when the child units have been synchronized with the parent unit.

In an alternate embodiment, the synchronization cradle may have a network or other connection that allows it to be connected to the computer. The use of a computer with the cradle may allow a user to program the software in the parent unit or child units. One embodiment for this would be programming the software on the parent unit regarding the settings or displays on a display screen of the parent unit. A connection between the synchronization cradle and a computer or computer-related device may allow for the parent and child units to be upgradeable.

It is to be understood that, while “synchronization” suggests congruence of timing between timing of two devices such as the parent and child units, no such timing relation is required. Rather, any exchange or alignment of identification or other data will provide the necessary synchronization. It is only required that the parent unit have some indication which child units are present and to be monitored. Any method of providing this information will synchronize the system.

Referring back to FIG. 2, after the child units are synchronized to a parent unit as in block 202, the parent unit may then sweep for all child units as in block 204. In one embodiment, the sweep is in the form of a transmission from the parent unit followed by a reception at the parent by a response transmission from respective child units. For example, on a field trip, if a teacher has a parent unit and the children all have child units, the parent unit will continually do a sweep by transmitting signals to the child units to ensure they are within a set range. When the child units receive the transmitted signals, they respond to the parent unit. The response is a normal condition and not further action is taken at the parent unit. When the child unit is out of range, it does not receive the transmitted signal from the parent unit and does not respond. The parent unit responds to the absent transmitted signal by, for example, triggering an alarm. The range is the distance the child unit can travel from the parent unit without triggering an alarm. In one embodiment, the range is 150 feet outside within a line of sight and 100 feet indoors.

In block 206, the child unit should respond to the signals. If the child unit responds, then the loop continues with the parent unit doing another sweep of signals. If the child unit does not respond as in block 208, an alarm is triggered in both the parent unit and the child unit. The features and details of the sweep and the alarms are discussed below.

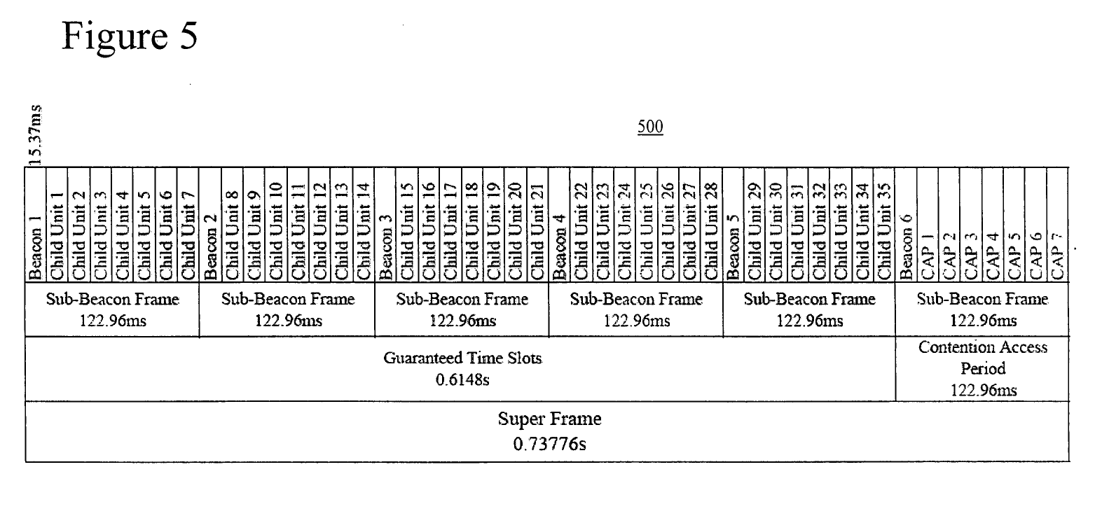

FIG. 5 is a diagram of the timing of an embodiment of a monitoring system. The chart 500 illustrates the timing sweep of a parent unit that has been synchronized to a group of 35 child units. The synchronization process maps all child units assigned to the parent units. Once established in parent unit memory as a roster or list, the software could be configured to sweep through all units in the roster evenly as demonstrated in chart 500. Alternatively, the software could cycle through this roster in a different pattern as specified by the parent unit. For example, Beacon 1 is a signal for the first seven child units. The time for that signal is 122.96 milliseconds. In one embodiment, a beacon is the signal the parent unit sends out during a sweep that is received by the child units and which they respond to. CAP 1-7 illustrates space for future roster growth.

Both the parent unit and the child units may contain a processor and radio frequency (“RF”) communication circuitry. The processor operates in response to instructions stored in memory. In one embodiment, the signals or sweeping of the parent unit with the child unit are performed using wireless protocol most similar to the 802.15.4 protocol also known as the ZigBee protocol. ZigBee is a high level communication protocol designed to use small, low power digital radios based on the Institute of Electrical and Electronics Engineers (IEEE) 802.15.4 standard for wireless personal area networks. The 802.15.4 wireless protocol is feasible in a rechargeable device in terms of power consumption, as well as a reasonable range. The ZigBee-related technology may be simpler and cheaper than other wireless personal area networks. The frequency range for communication may be 2.4 GHz. This frequency range requires less power than other possible operating frequencies. Reduced power consumption is an important operating characteristic for battery-powered devices such as the parent unit and the child unit of the present system. The 802.15.4 wireless protocol may be adapted so that all control functions are assigned to the parent unit, so the parent unit controls all communications. In that embodiment, the child unit only speaks when spoken to. In an alternative embodiment, any other wireless protocol may be utilized that is now available or later developed.

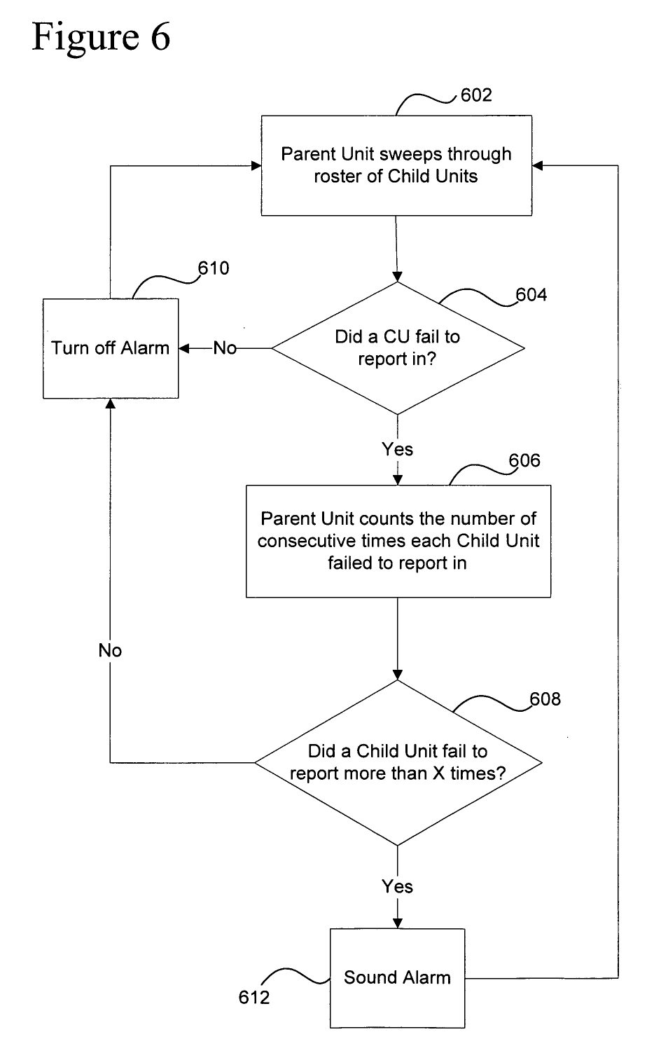

FIG. 6 is a flow chart showing steps of identifying a missing child unit from the perspective of a parent unit according to one embodiment. In block 602, the parent unit sweeps through the roster of child units. A sweep may be the signal transmitted by the parent unit, which is used to check on the status of each of the child units. Each sweep is a transmitted signal from the parent unit, which when each child unit responds to in order to notify the parent unit that it is within range. A sweep may occur several times per second. In block 604, the parent unit monitors whether any of the child units failed to report back to the parent unit. If no child units failed to report, then there is no alarm as in block 610 and the parent sweeps through the roster again. If a child unit does fail to respond to the parent unit as in block 604, the parent unit monitors the number of consecutive times the child unit fails to report back to or communicate with the parent unit as in block 606. If the child unit does report to the parent in block 608, then there is no alarm and the parent unit continues to sweep. In block 608, if the child unit fails to report after a certain number of sweeps, then the parent unit alarm is triggered in block 612. The parent unit determines how many consecutive sweeps a particular child unit has failed to report back to the parent unit after. If the number of sweeps exceeds the threshold, then the alarm is triggered. In one embodiment, the parent unit may require three consecutive sweeps without hearing from a child unit to trigger the alarm.

In one embodiment, the time during each sweep for each child unit is fixed. In an alternate embodiment, the sweep may be customized to look longer for certain child units. For example, if a class includes one special needs child, or one who just tends to get in a lot of trouble and requires extra attention, the sweep parameter for that child unit may be set to alert the parent sooner or faster than the other kids. Also, there may be additional sweeps to check for particular child unit more frequently than the other students.

The alarm, as in block 612, for the parent unit may operate in a variety of different ways. It may generate a sound such as a ringing or chirping. The volume of the audible alarm may be roughly 90 decibels, but any suitable volume level may be chosen. Alternatively, there may be a light or light emitting diode (LED) that is triggered by the alarm. The parent unit may vibrate when the alarm is triggered. In one embodiment, the parent unit may be able to switch alarm modes or may utilize any combination of sound, LED, or vibration as an alarm. The monitoring system may provide additional security for special needs students and teachers through its alarm system, particularly for students who are prone to wandering or at-risk when unsupervised. The three options for the alarm, the sound, LED and vibration are effective for monitoring a variety of students or children.

In one embodiment, the display 19 of the parent unit 10 (from FIG. 1) may be a liquid crystal display (LCD). The display may include an identification of the child unit that triggered the alarm and is outside of the range of the parent unit. The identification may be a number of the child unit, or may have the name of the child programmed into the parent unit. Alternatively, all the child units may be named rather than numbered, such as naming all the child units after animals or birds. The child units could also be identified based on color. The parent unit would display that the “tiger” child unit is missing or that the “green” child unit is missing. The parent or teacher may have a roster list identifying which student or child has which child unit. For example, “Joey Smith” may have the “Eagle” child unit.

In an alternate embodiment, the display may include the last known location of a missing child unit. For example, the parent unit may display a compass indicating the direction the child unit was going when the range was exceeded. If multiple child units trigger the parent alarm, the display may indicate all of the child units whose alarms were triggered, or notify the parent unit of multiple breaches. In one embodiment, the complementary use of an antenna and triangulation software may be used to determine a relative location and distance of a child unit from the parent unit.

The display on the parent unit may include a variety of other features. In addition to information about the child units being monitored, the parent unit display may include an indicator of the charge in the battery or allow the parent to change the alarm type. The parent unit may include an option for setting the range. Therefore, the teacher on a field trip could adjust the range as the students are moving to different areas. For example, the teacher may want a small range of 20 feet in a crowded museum, or 150 feet in an open park. The teacher may adjust the range based the relevant circumstances. In an alternate embodiment, the parent unit may offer a finite number of ranges. For example, the parent unit may allow for a short range (e.g., 50 feet), a medium range (e.g., 100 feet), or a long range (e.g., 150 feet).

In one embodiment, the display may include a single actuator (up-down) that controls the display screen. The parent may hold the actuator in one direction to scroll through the screen. This may be similar to the clock button on a typical car radio-clock. After holding the button for a set amount of time, it starts to flash.

The parent unit may also include a button or display option that allows for a particular child unit to temporarily suspend monitoring, for example to have a bathroom break. In such a scenario, the parent may use the display to select the child unit or child units that will go on a bathroom break and the parent will select a break option that allows for those units to leave the range of the parent unit for a set amount of time. In one embodiment, the break button would be a 5-minute pass, after which the alarm may be triggered in both the parent unit and the child unit. The child unit may include a warning which notifies the child when the five minute break period is almost expired and an alarm that is triggered if the child fails to return from the break. During the break period, sweeping by the parent of the child unit may be suspended or continued but, if continued, the missing responses from the child unit are excused. If the child unit does not respond to a sweep at the end of the break period, the alarm may be triggered. Alternatively, there may be a rest button with similar functionality, which the parent may use to temporarily disable the monitoring of the system, such as when the parent may need a bathroom break.

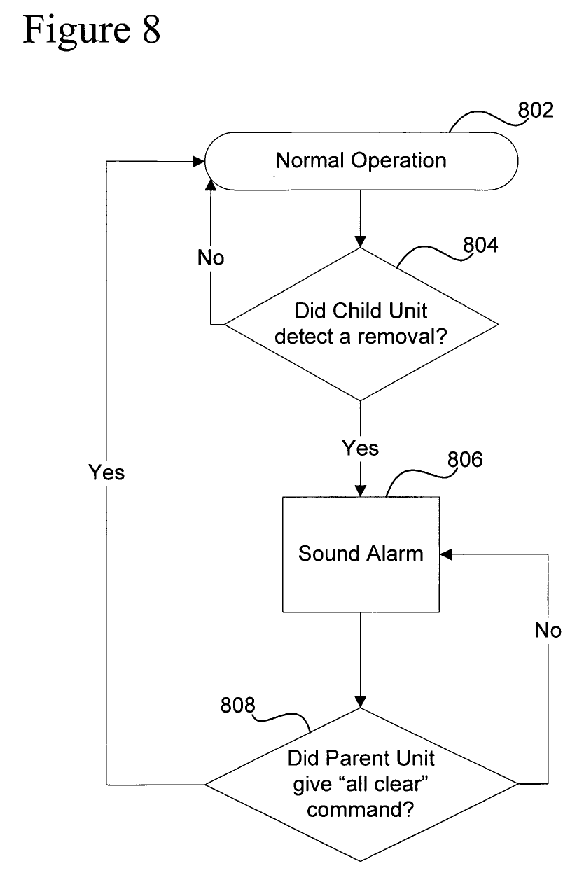

In an alternate embodiment, the LED on the parent unit may include different colors to represent different occurrences. For example the LED may be yellow if a child is outside of the range of the parent unit. Alternatively, the LED may be red if the child unit is removed from one of the children as is discussed in conjunction with FIG. 8. The LED may be green if the child presses the distress button as discussed above.

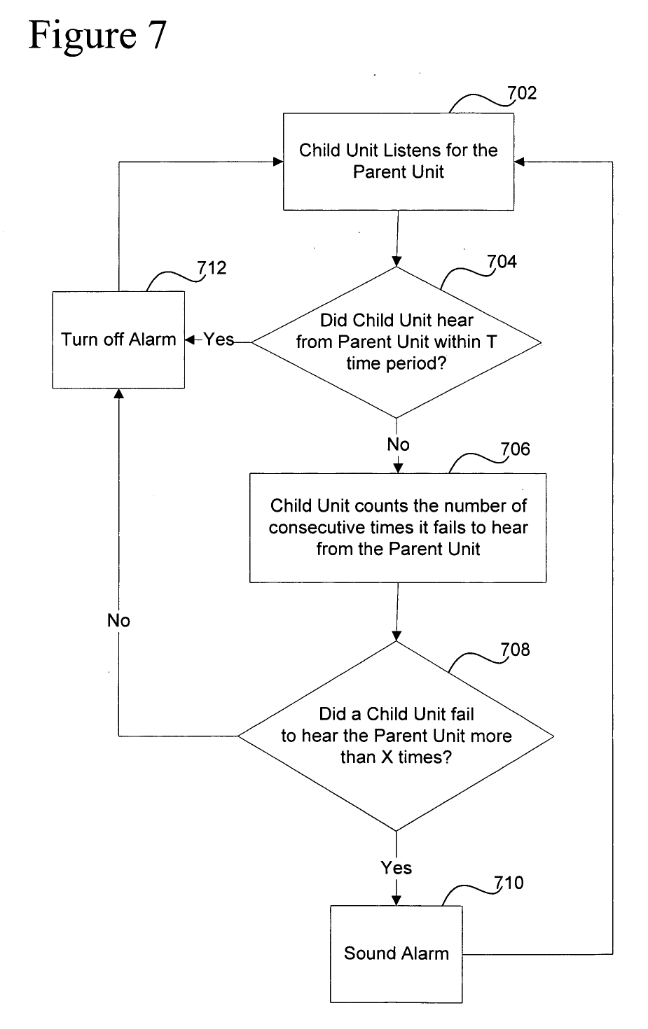

FIG. 7 is a flow chart showing steps of a missing child unit from the perspective of the missing child unit according to one embodiment. The parent unit sends out a call beacon or signal and if the child unit fails to reply within a certain number of sweeps, the child unit alarms, as does the parent unit as discussed above. The frequency of transmission may be 2.4 GHz or another common-use FCC sanctioned band. In one embodiment, the number of sweeps after which the alarm is triggered is three, which may take less than two seconds.

In block 702, the child unit listens for the parent unit. The child unit waits to hear a beacon or signal from the parent unit. In block 704, the child unit listens for a certain period of time to hear from the parent unit. If the child unit hears from the parent unit within a certain amount of time, then there is no alarm as in block 712, and the child unit continues to listen for the next signal from the parent unit. In one embodiment, the child unit may wait for half a second or a couple of seconds to hear from the parent unit. If the child unit does not hear from the parent unit during that time, the child unit monitors the number of times that it has failed to hear from the parent unit as in block 706. As in block 708, if the child unit hears from the parent unit within a certain number of sweeps, then there is no alarm as in block 712. If the child unit fails to hear from the parent unit within a certain number of sweeps, then the alarm is triggered as in block 710.

The most common cause of an alarm would be if the child exceeds the range established by the parent unit. The child unit fails to hear or receive the parent unit's signals and therefore does not respond. The parent unit does not receive a response from the child unit. The alarm on both the parent unit and the child unit are triggered. If the child then moves back within range of the parent unit, the alarms stop. Alternatively, the parent may stop the alarms with the parent unit. The parent unit may have an “all clear” button that signals the child unit and stops the alarm on the parent unit. In the case of multiple breaches, the parent unit display may also have an option on the display for stopping the alarm of those child units that the parent knows are safe.

Many of the features in the child unit may be similar to the parent unit. However, in one embodiment, the child unit may be much simpler in construction and operation. In this embodiment, the child unit does not have a display or the other options that are provided in the parent unit. The other alarm capabilities of the parent unit may be replicated in the child unit. Further, the child unit may also have a distress button. If the child feels as if he or she is in danger, the child can actuate the distress button and the alarms for both the parent unit and the child unit will be triggered. The child unit may produce a very loud noise that could scare away a potential kidnapper.

The LED light in the child unit may have multiple colors for different scenarios as in the parent unit. For example, the LED may be yellow to warn the child that he/she is approaching the range limit or outer boundary established by the parent unit. Alternatively, a color LED may notify the child that the end of a break is nearing. The LED may also display a color, which signifies that the child unit is running out of battery.

FIG. 8 is a flow chart showing the steps in a monitoring system according to one embodiment when a child unit is removed. The alarm for removal of a child unit may prevent a child or potential kidnapper from merely removing the child unit and notify the parent unit in such a circumstance. The parent unit and the child unit may both have an alarm triggered if the child unit is removed from the child. In one embodiment, the parent unit may be notified by a different alarm that the child unit was removed. This enables the parent to distinguish between a child who exceeded the range of the parent unit versus a child whose child unit was removed.

In block 802, the parent unit is continually sweeping for all of the child units it is responsible for monitoring. In block 804, the child unit detects whether the child unit was removed. If the child unit was removed from the child, then the alarm is triggered in block 806. The alarm will continue until the parent unit signals that everything is all clear as in block 808. The all clear signal may be through the use of a rest or break button, or may be a separate option on the parent unit.

The child unit may be attached to the child on the child's clothing. In one embodiment, there may be a clasp that is fastened to the clothing, such as the top of the child's pants above the belt loop, or to a child's shirt. In an alternate embodiment, there may be a lanyard accessory that is placed loosely around the child's neck. The child unit may include a locking device, which is operable to couple the child unit to a child. The child unit could also have a belt accessory that is securely fastened to the child's arm, leg, or waist.

The child unit may be operable to know when the unit is removed from the child. In one embodiment, the child unit may use two electrical contacts to measure current flow through the skin or capacitance of one contact point. Alternatively, a fastener may trigger the alarm when it is unfastened. For example, if the fastener is a clip, then the release of that clip would trigger the alarm in the child unit. The child unit may send a signal to the parent unit notifying it that the child unit has been removed from the child, or it may include that information in its standard response to the parent unit's sweep signal.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive or limiting, and the appended claims are intended to cover all such modifications, enhancements, and other embodiments, which fall within the true spirit and scope of the present invention. Thus, to the maximum extent allowed by law, the spirit and scope of the present invention is to be determined by the broadest permissible interpretation of the following claims and their equivalents, and shall not be restricted or limited by the foregoing detailed description.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

1. A system comprising:
a parent unit, wherein the parent unit transmits signals; and
at least one child unit, which receives the transmitted signals from the parent unit, wherein the at least one child unit initiates an alarm on the at least one child unit upon failing to receive the transmitted signal from the parent unit after a predetermined amount of time; and
further wherein the parent unit is operable to identify the at least one child unit when the at least one child unit fails to respond to the transmitted signal from the parent unit and initiates an alarm on the parent unit.

2. The system of claim 1, further comprising:
a synchronization device, wherein the synchronization device associates the parent unit with the at least one child unit.

3. The system of claim 2, wherein the association of the parent unit with the at least one child unit comprises the parent unit recording unique identifiers for a roster of each of the at least one child units.

4. The system of claim 1, wherein the transmitted signals from the parent unit are transmitted using an 802.15.4 wireless protocol.

5. The system of claim 1, wherein the transmitted signals from the parent unit are transmitted at a rate of approximately three times per second.

6. The system of claim 1, wherein the at least one child unit is coupled with an asset to be monitored through at least one of a button, a lanyard, a locking device, or combinations thereof.

7. The system of claim 1, wherein the at least one child unit fails to respond to the transmitted signal from the parent unit when the at least one child unit exceeds a predetermined distance from the parent unit.

8. The system of claim 7, wherein the at least one child unit initiates an alarm when the at least one child unit is removed from the asset to be monitored.

9. The system of claim 1, wherein the alarm from the at least one child unit and the alarm from the parent unit comprises at least one of a vibration, a light, a sound, or combinations thereof.

10. A method of monitoring assets comprising:
providing a parent device and at least one child device;
synchronizing the at least one child device with the parent device;
communicating signals between the parent device and the at least one child device;
initiating an alarm on the at least one child device when the at least one child device fails to receive a predetermined number of signals from the parent device;
initiating an alarm on the parent device when the at least one child device fails to respond to the predetermined number of signals from the parent device; and
identifying the at least one child device that initiates the alarm on the parent device.

11. The method of claim 10, wherein the step of synchronizing comprises:
inserting the parent device and the at least one child device into a synchronization device;
associating the at least one child device with the parent device;
storing information regarding the at least one child device into the parent device; and
removing the parent device and the at least one child device from the synchronization device.

12. The method of claim 11, wherein the step of associating the at least one child device with the parent device comprises the parent device recording unique identifiers for each of the at least one child devices.

13. The method of claim 10, wherein the step of communicating signals between the parent device and the at least one child device comprises communications using an 802.15.4 wireless protocol.

14. The method of claim 10, wherein the child device is coupled with an asset to be monitored.

15. The method of claim 10, wherein the alarm from the at least one child device and the alarm from the parent device is at least one of a vibration, a light, a sound, or combinations thereof.

16. The method of claim 10, wherein the at least one child device fails to respond to the predetermined number of signals when the at least one child device exceeds a predetermined distance from the parent unit.

17. A system comprising:
a monitoring unit;
at least one monitored unit which communicates with the monitoring unit, wherein the monitoring unit is operable to determine if the monitored unit exceeds a certain distance from the monitoring unit; and
a synchronization device, wherein the synchronization device is a cradle that receives the monitoring unit and receives the at least one monitored unit and associates the monitoring unit with the at least one monitored unit.

18. The system of claim 17, wherein the synchronization device is operable to allow the identity of each of the at least one monitored units to be recorded by the monitoring unit.

19. The system of claim 18, wherein the monitoring unit is operable to identify the at least one monitored unit when the at least one monitored unit exceeds a certain distance from the monitoring unit.

20. The system of claim 19, wherein an alarm is triggered when the at least one monitored unit exceeds the certain distance from the monitoring unit.

21. The system of claim 17, wherein the at least one monitored unit is coupled with an asset to be monitored.

22. A method of monitoring pets, the method comprising:
providing a parent device and at least one child device;
synchronizing the at least one child device with the parent device;
coupling each of the at least one child device with at least one pet;
communicating signals between the parent device and the at least one child device;
initiating an alarm on the at least one child device when the at least one child device fails to receive a predetermined number of signals from the parent device; and
initiating an alarm on the parent device when the at least one child device fails to respond to the predetermined number of signals from the parent device;
wherein the alarm on the at least one child device and the alarm on the parent device is triggered when the at least one pet exceeds a predetermined distance from the parent device.

23. The method of claim 22, wherein the alarm on the at least one child device is established to prevent the at least one pet from going beyond a boundary established by the predetermined distance.

24. The method of claim 22, further comprising identifying the at least one child device that fails to respond to the predetermined number of signals from the parent device.

25. A method for monitoring a patient, the method comprising:
providing a monitoring unit and at least one monitored unit;
synchronizing the at least one monitored unit with the monitoring unit;
coupling the at least one monitored unit with the patient;
communicating signals between the monitoring unit and the at least one monitored unit; and
initiating an alarm on the monitoring unit when the at least one monitored unit fails to respond to the monitoring unit when the at least one patient exceeds a predetermined distance from the monitoring unit;
wherein the monitoring unit is operative to identify the at least one monitored unit that failed to respond.
